(19) United States
(12) Patent Application Publication
(10) Pub. No.: US 2009/0066178 A1
(43) Pub. Date: Mar. 12, 2009

(54) ELECTRIC MOTOR APPARATUS CAPABLE OF REDUCING FRICTION

(75) Inventor: Chun-Ju Lin, Taipei County (TW)

Correspondence Address: BACON & THOMAS, PLLC, 625 SLATERS LANE, FOURTH FLOOR, ALEXANDRIA, VA, 22314-1176, US

(73) Assignee: TEK-CHAIN TECHNOLOGY CO., LTD, Taoyuan County (TW)

(21) Appl. No.: 12/274,676

(22) Filed: Nov. 20, 2008

Related U.S. Application Data
(62) Division of application No. 11/713,647, filed on Mar. 5, 2007.

(51) Int. Cl. H02K 5/173; F04D 25/08

(52) U.S. Cl. 310/90; 417/352

(57) ABSTRACT

This invention discloses an electric motor apparatus including a frame, a stator and a rotor in the frame, an axle sleeve at the center of the stator and having an embedded groove extended inwardly and at a free end apart from the connecting position of the frame, a bearing sheathed into the axle sleeve, an axle at the center of the rotor and sheathed into the bearing, a latch at an internal side of the rotor and protruded outward for securing the stator and the rotor, and a ball embedded in the bearing and apart from the free end. By the embedded groove and latch, the stator and rotor are combined, and the axle is pressed against the ball. When the axle is rotated, the ball is driven to roll to reduce the friction, noises and wearing as well as enhancing the life expectancy and efficiency of the electric motor.

### BACKGROUND OF THE INVENTION

1. Field of the Invention

The present invention relates to an electric motor apparatus capable of reducing friction, and more particularly to an electric motor apparatus that presses an axle at a ball to roll the ball when the axle is rotated, so as to achieve the effects of reducing the friction produced between the axle and the bottom of a bearing, reducing noises and wearing of the axle, and enhancing the life expectancy and efficiency of an electric motor.

2. Description of the Related Art

Referring to FIG. 1 for a heat dissipating fan of a computer in accordance with a prior art, the heat dissipating fan comprises a stator 100, a rotor 200 and a fan body 300 disposed on the rotor 200, wherein the stator 100 is comprised of a bearing 101 disposed at the middle of the stator 100 and a permanent pole 102 disposed at the periphery of the stator 100, and the rotor 200 is comprised of an axle 201 and a permanent magnet 202 disposed around the internal periphery of the fan body 300. The axle 201 is pivotally coupled into bearing 101 of the stator 100, such that when the rotor 200 is rotated to drive the fan body 300 to rotate, the fan body 300 produces turbulences while the current is producing a dragging reaction along the axial direction for both of the fan body 300 and the rotor 200, Therefore, axial vibrations and unstable conditions will occur at the axle 201 of the rotor 200 during its rotation, and the volume of noises will be increased. In view of these shortcomings, related manufacturers developed a heat dissipating fan structure and introduced an enhanced design for the rotation of the axle 201 of the rotor 200 by installing a magnetic pressing member 103 at the bottom of the bearing 101 of the stator 100, and using the top of the pressing member 103 for pivotally pressing the bottom of the axle 201 of the rotor 200, while producing an axial suction to stabilize the rotor 200. However, the conventional structure still has the following issues in its practical applications.

Since the bottom of the axle 201 of the rotor 200 is pivotally and directly pressed at the top of the pressing member 103, therefore the high-speed rotating axle 201 will wear out the top of the pressing member 103 after a long time of use, and the rotor 200 will be deviated to a lower position, and the precision of configuration will be lost. As a result, the normal operations of the rotor will be affected, and such arrangement cannot meet user requirements.

On the other hand, the conventional structure usually adopts a magnetic pressing member 103 in a plate-like shape. If the thickness is insufficient to meet the expected magnetism requirement, then it is necessary to increase the thickness of the magnetic pressing member, and thus a higher cost will be incurred.

To overcome the foregoing shortcomings, a fan structure as shown in FIG. 2 comprises a stator 100, a rotor 200 and a fan body 300; wherein the stator 100 has a bearing 101 protruded from the center of the stator 100, and the stator 100 installs a permanent pole 102; and the rotor 200 is comprised of an axle 201 and a permanent magnet 202 disposed around the internal periphery of the fan body 300, and the permanent magnet 202 and the permanent pole 102 of the stator 100 have interactions of magnetic fields with each other; and the bottom of the bearing 101 has a magnet for pivotally pressing the axle 201 of the rotor, and the magnet includes a magnetic circular body 401 and a magnetic metal member 402 disposed in the magnetic circular body 401, and the magnetic circular body 401 is fixed at the bottom section of the bearing 101, and the magnetic metal member 402 is fixed into a circular hole of the magnetic circular body 401, and the top of the magnetic metal member 402 is provided for pivotally pressing the bottom of the axle 201 of the rotor 200. With the assembly and structural configuration of the magnet, the magnetic metal member 402 can transmit a magnetic force of the magnetic circular body 401 to obtain a magnetic attraction, but such arrangement will increase the area of frictions and the manufacturing cost.

In view of the shortcomings of the prior art, the inventor of the present invention based on years of experience in the related industry to conduct extensive researches and experiments, and finally developed an electric motor apparatus capable of reducing friction in accordance with the present invention.

### SUMMARY OF THE INVENTION

Therefore, it is a primary objective of the present invention to provide an electric motor apparatus applied to an electric motor for effectively reducing the friction produced between an axle and a bearing, decreasing the noise and wearing of the axle when the electric motor is rotated, and further improving the life expectancy and efficiency of a fan.

Another objective of the present invention is to provide an electric motor apparatus that installs a stator and a rotor thereon, wherein the stator has an axle sleeve, an embedded groove extended inward and disposed at an internal side of an opening at a free end of the axle sleeve, and the axle sleeve is sheathed with a bearing; and the rotor has an axle sheathed into the bearing, and a latch disposed at an internal side of the rotor and corresponding to the embedded groove. With the embedded groove and the latch, the stator and the rotor can be latched with each other easily.

A further objective of the present invention is to embed a ball into an end apart from the free end of the bearing, such that the axle and the ball are pressed closely with each other, and the axle is rotated to drive and roll the ball.

Another objective of the present invention is to sheathe the ball into the internal periphery of the bearing for installing the ball into the bearing, and examine whether or not any deformation or rough edge is produced at the internal periphery.

Another objective of the present invention is to build a slot along the axial direction and at the periphery of the embedded groove, such that the slot can provide an elasticity of expanding and contracting the embedded groove.

### BRIEF DESCRIPTION OF THE DRAWINGS

FIG. 1 is a cross-sectional perspective view of a prior art;

FIG. 2 is another cross-sectional perspective view of a prior art;

FIG. 3 is an exploded view of the present invention;

FIG. 3A is an enlarged view of a bearing of the present invention;

FIG. 4 is a cross-sectional view of the present invention;

FIG. 4A is an enlarged view of combining an axle sleeve and an axle in accordance with the present invention;

FIG. 5 is a cross-sectional view of an assembly of the present invention; and

FIG. 6 is a cross-sectional view of another preferred embodiment of the present invention.

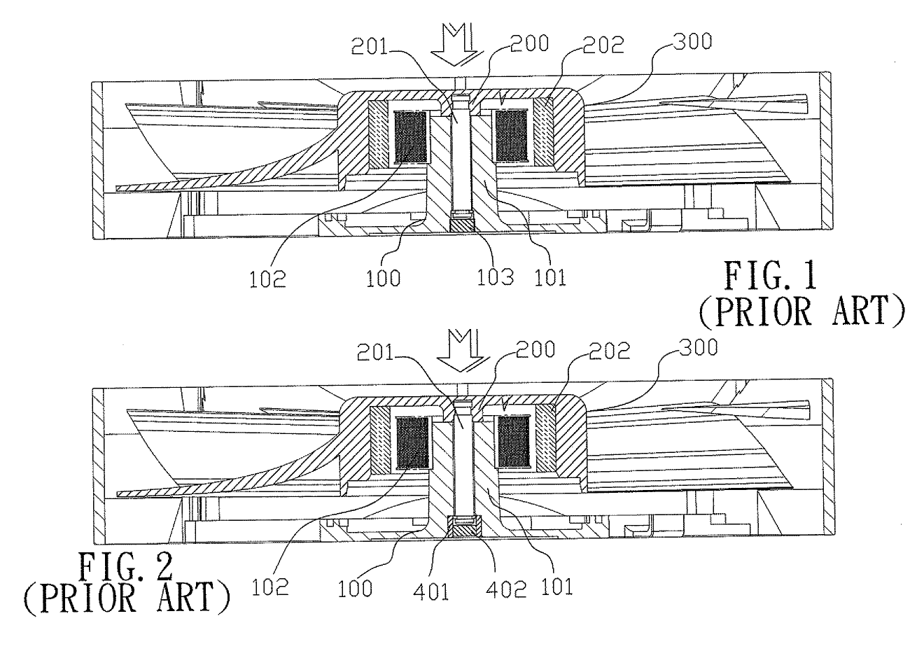

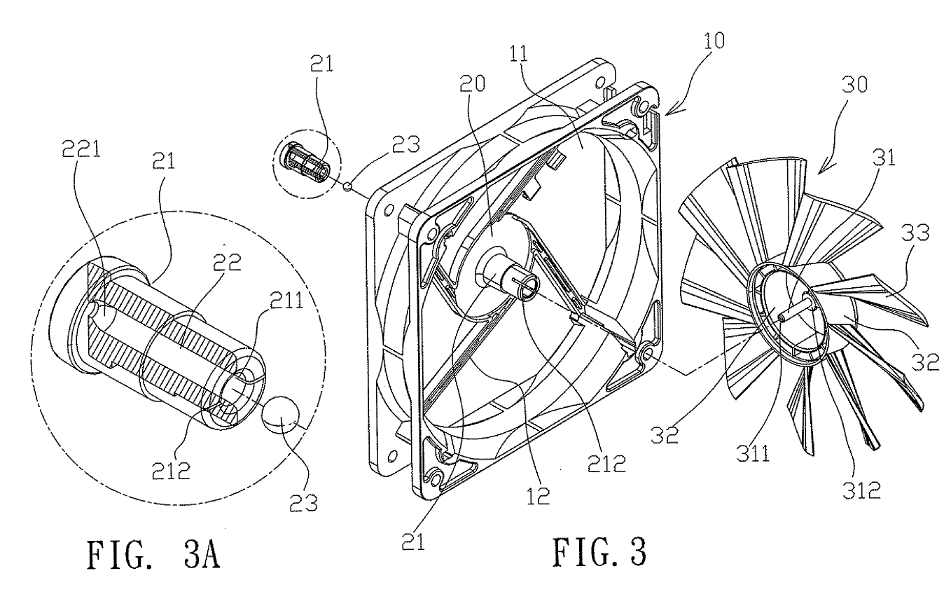

### DETAILED DESCRIPTION OF THE PREFERRED EMBODIMENTS

To make it easier for our examiner to understand the technical characteristics of the invention, we use preferred embodiments together with the attached drawings for the detailed description of the invention.

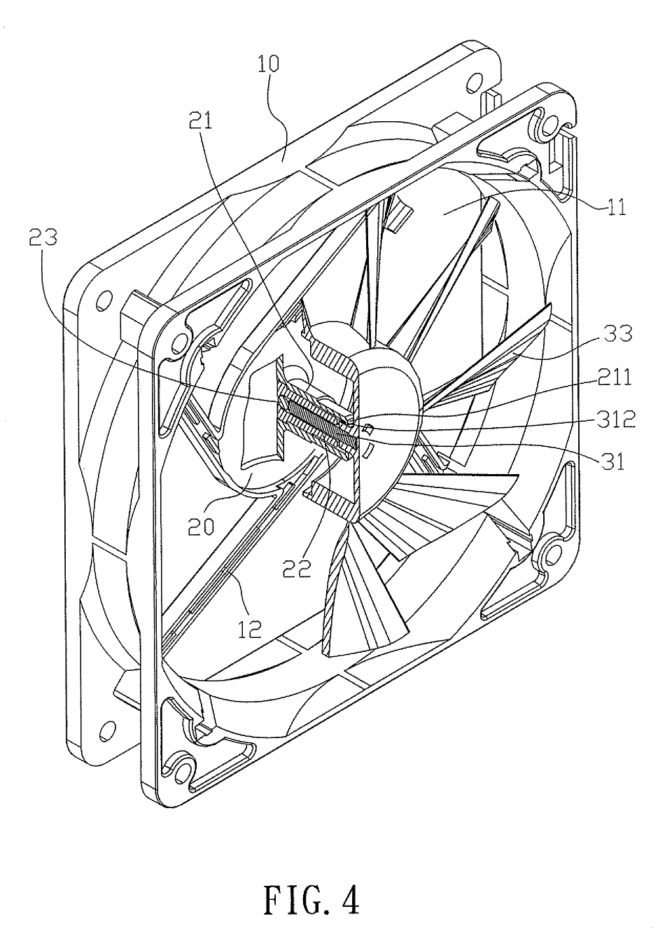

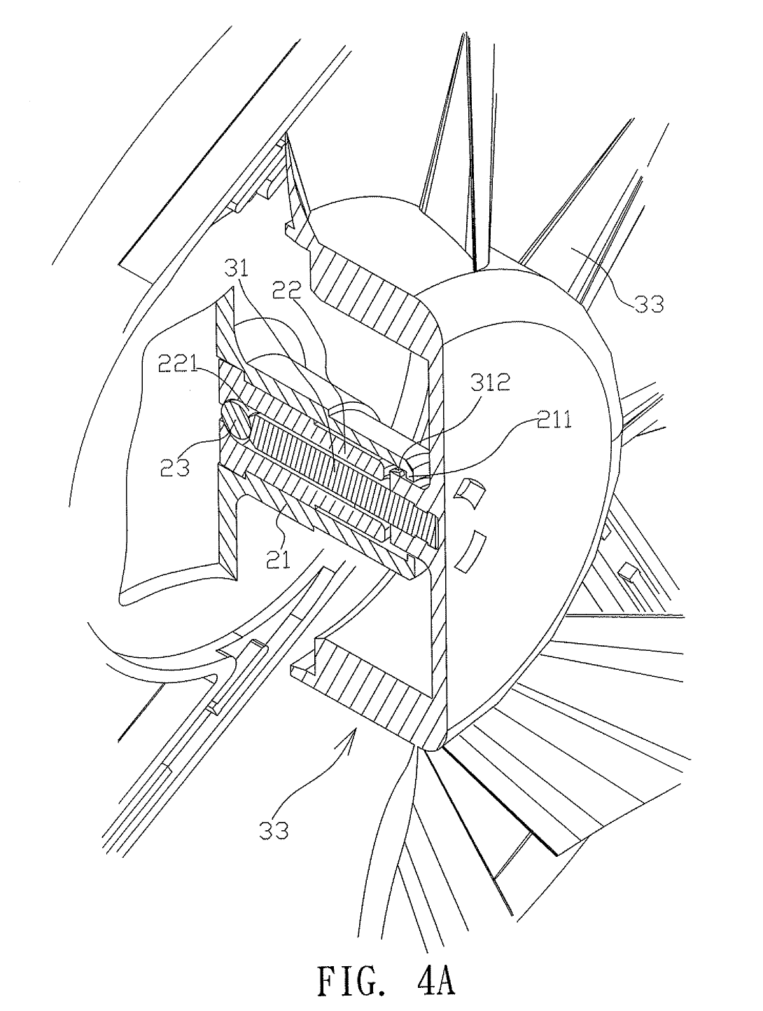

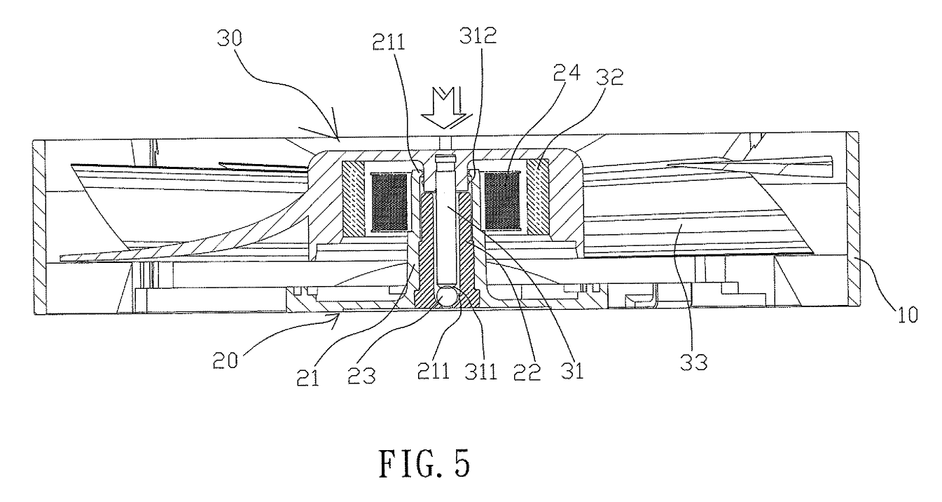

Referring to FIGS. 3, 3A, 4, 4A and 5 for a preferred embodiment of the present invention, an electric motor apparatus comprises a frame 10, an opening 11 penetrating the frame 10, and a stator 20 and a rotor 30 contained in the frame 10; wherein the stator 20 is installed at the middle of the opening 11, and the periphery of the stator 20 is connected to the frame 10 by a rib 12, and an axle sleeve 21 (which is made of a plastic material in this embodiment) disposed perpendicularly at the central position of the stator 20, and an embedded groove 211 (as shown in FIG. 4A) extended inward and disposed at an internal side of a distal edge of a free end of the axle sleeve 21, and the embedded groove 211 has a slot 212 disposed along its axial direction, such that the slot 212 can provide an elasticity for expanding and contracting the embedded groove 211. Further, the axle sleeve 21 is sheathed with a hollow bearing 22 (made of a plastic material in this embodiments, and the bearing 22 has a containing groove 221 proximate to an end of the stator 20 and the containing groove 221 is embedded with a ball 23. When the ball 23 is installed into the bearing 22, the ball 23 is sheathed into the internal periphery of the bearing 22, and simultaneously examines whether or not any deformation or rough edge is produced. Further, a permanent pole 24 is disposed around the periphery of the axle sleeve 21; wherein the center of the rotor 30 has an axle 31, and a permanent magnet 32 is disposed around the internal periphery of the rotor 30, and a plurality of radially arranged vanes 44 are disposed around the external periphery of the rotor 30, and the axle 31 is sheathed into the bearing 22, and has a concave groove 311 at its free end, and the concave groove 311 is pressed and contacted with the surface of the ball 23. Further, the internal side of the rotor 30 has a protruding latch 312, embedded precisely into the embedded groove 211 (as shown in FIGS. 4 and 5) by the expansion and contraction of the latch 312.

Referring to FIGS. 4, 4A, 5, the axle 31 is sheathed into the bearing 22, and the concave groove 311 of the axle 31 is pressed onto the ball 23, and the latch 312 is embedded successfully into the embedded groove 211 through the slot having the expanding and contracting effects (as shown in FIG. 3), such that the stator 20 and the rotor 30 are combined. The electromagnetic effect between the permanent pole 24 of the stator 20 and the permanent magnet 32 of the rotor 30 drives and rotates the rotor 30, such that when the rotor 30 is rotated, the axle 31 also rotates in the bearing 22 accordingly. With the installation of ball 23, the ball 23 is driven and rolled, so as to achieve the effects of reducing the friction between the axle 31 and the bottom of the bearing 22, decreasing noises and the wearing of the axle, and improving the life expectancy and efficiency of the fan.

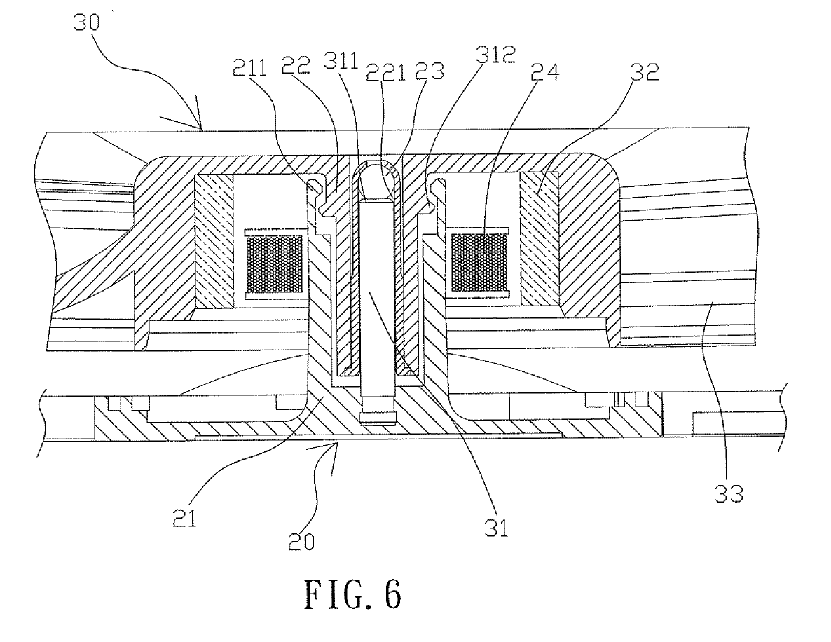

Referring to FIG. 6 for another preferred embodiment of the present invention, the major difference of this embodiment with the foregoing embodiment resides on that the axle 31 is fixed into the axle sleeve 21 of the stator 20, and the axle 31 has a concave groove 311 disposed at an end apart from the free end of the stator 20. Further, an embedded groove 211 is extended inwardly and disposed at an internal side of a distal edge of the free end of the axle sleeve 21, and the embedded groove 211 has a slot 212 (not shown in the figure) along the axial direction for providing an elasticity of expanding and contracting the embedded groove 211. Further, the middle of the rotor 30 has a hollow bearing 22, sheathed into the axle sleeve 21 and the axle 31 at the same time, and an end of the bearing 22 proximate to the rotor 30 has a containing groove 221 for embedding a ball 23, and the surface of the ball 23 is pressed against the concave groove 311, and the internal side of the rotor 30 has a protruding latch 312, such that the latch 312 can be embedded precisely into the embedded groove 211 by the expansion and contraction of the embedded groove 211.

In summation of the above description, the design of the present invention herein enhance the performance and improve the life expectancy of an electric motor than the conventional structure and further complies with the patent application requirements and is duly filed for a patent application.

While the invention has been described by means of specific embodiments, numerous modifications and variations could be made thereto by those skilled in the art without departing from the scope and spirit of the invention set forth in the claims.

What is claimed is:

1. An electric motor apparatus capable of reducing friction, comprising:
a frame, for installing a stator and a rotor therein;
an axle sleeve, installed at the center of said stator, and having an embedded groove extended inwardly and disposed at a free end far apart from a position connected to said rotor;
a bearing, being a hollow circular body, and fixed at the center of said rotor and sheathed into said axle sleeve, and having a containing groove disposed at an end proximate to said rotor for containing a rollable ball;
an axle, installed at the center of said rotor, and sheathed into said bearing;
a latch, installed at an internal side of said rotor, and protruded outward to match with said embedded groove to secure said stator and said rotor with each other;
thereby, said stator and said rotor are engaged with each other easily by said embedded groove and said latch, and said axle is pressed against said ball in said containing groove, and said axle is rotated to drive and roll the ball, so as achieve the effects of reducing the friction produced at the bottom of said bearing, decreasing noises and the wearing of said axle, and enhancing the life expectance and efficiency of an electric motor.

2. The electric motor apparatus capable of reducing friction of claim 1, wherein said axle has a concave groove disposed at a free end of said axle.

3. The electric motor apparatus capable of reducing friction of claim 1, wherein said embedded groove includes an axial slot for providing an elasticity of expanding and contracting said embedded groove.

4. The electric motor apparatus capable of reducing friction of claim 1, wherein said axle sleeve and said bearing are made of a plastic material.

5. The electric motor apparatus capable of reducing friction of claim 1, wherein said electric motor apparatus is a heat dissipating fan used in a computer.
